(19) United States
(12) Patent Application Publication
(10) Pub. No.: US 2007/0213157 A1
(43) Pub. Date: Sep. 13, 2007

(54) Endless belt for conveying paper sheet and method for producing the endless belt

(75) Inventor: Shuhei Noda, Yokohama-shi (JP)

Correspondence Address: SUGHRUE MION, PLLC, 2100 PENNSYLVANIA AVENUE, N.W., SUITE 800, WASHINGTON, DC, 20037, US

(73) Assignee: HOKUSHIN CORPORATION

(21) Appl. No.: 11/714,816

(22) Filed: Mar. 7, 2007

(30) Foreign Application Priority Data
Mar. 8, 2006 (JP) 2006-063184
Mar. 1, 2007 (JP) 2007-052070

(51) Int. Cl. F16G 1/00; F16G 9/00

(52) U.S. Cl. 474/237

(57) ABSTRACT

The present invention provides a paper-sheet-conveying endless belt which is produced through a small number of production steps, which includes a thin core member, and which exhibits excellent durability. The paper-sheet-conveying endless belt includes a core member formed of a heat-shrinkable tube, and a rubber-like elastic member provided thereon.

The entire disclosure of Japanese Patent Applications Nos. 2006-063184 filed Mar. 8, 2006 and 2007-052070 filed Mar. 1, 2007 is expressly incorporated by reference herein.

### BACKGROUND OF THE INVENTION

1. Field of the Invention

The present invention relates to an endless belt for conveying a paper sheet in, for example, an automatic ticket gate, a cash depositing/dispensing machine, or a bill changer (hereinafter the endless belt may be referred to as a “paper-sheet-conveying endless belt); and to a method for producing the endless belt. As used herein, the term “paper sheet” encompasses a variety of paper sheets, PPC sheets, a variety of films, magnetic cards, tickets, banknotes, and coins.

2. Background Art

In a conventionally employed automatic ticket gate, cash depositing/dispensing machine, bill changer, automatic ticketing machine, etc., a paper sheet (e.g., a banknote, a magnetic card, or a ticket) is sandwiched between belts provided so as to face each other, and is then conveyed by means of sandwiching force between the belts. In general, such a belt is constituted by a rubber belt including a core member formed of nylon or polyester fiber, and a rubber-like elastic member provided thereon (see, for example, Japanese Patent Application Laid-Open (kokai) Nos. H10-017173 and 2000-255815).

However, the aforementioned belt poses a problem in conveying a paper sheet, due to disentanglement of fiber filaments constituting the core member of the belt. In addition, the aforementioned belt poses problems in that, for example, the belt requires a complicated production process, and the core member, which has a large thickness, prevents the rubber-like elastic member from exhibiting sufficient mechanical properties.

### SUMMARY OF THE INVENTION

In view of the foregoing, an object of the present invention is to provide a paper-sheet-conveying endless belt which is produced through a small number of production steps, which comprises a thin core member, and which exhibits excellent durability. Another object of the present invention is to provide a method for producing this endless belt.

Accordingly, in a first mode of the present invention, there is provided a paper-sheet-conveying endless belt comprising a core member formed of a heat-shrinkable tube, and a rubber-like elastic member provided thereon.

A second mode of the present invention is directed to the paper-sheet-conveying endless belt of the first mode, wherein the core member has a through-hole which penetrates therethrough in a thickness direction, and the through-hole is filled with the rubber-like elastic member.

A third mode of the present invention is directed to the paper-sheet-conveying endless belt of the first or second mode, wherein the rubber-like elastic member is formed from a castable polyurethane.

A fourth mode of the present invention is directed to the paper-sheet-conveying endless belt of any of the first to third modes, wherein the heat-shrinkable tube has a percent shrinkage of 0.5 to 10%.

A fifth mode of the present invention is directed to the paper-sheet-conveying endless belt of any of the first to fourth modes, wherein the core member has a thickness of 20 to 500 μm.

A sixth mode of the present invention is directed to the paper-sheet-conveying endless belt of the fifth mode, wherein the thickness of the core member is 20 to 200 μm.

A seventh mode of the present invention is directed to the paper-sheet-conveying endless belt of any of the first to sixth modes, wherein the ratio of the thickness of the core member to the overall thickness of the endless belt is 5 to 80%.

An eighth mode of the present invention is directed to the paper-sheet-conveying endless belt of the seventh mode, wherein the ratio of the thickness of the core member to the overall thickness of the endless belt is 5 to 20%.

A ninth mode of the present invention is directed to the paper-sheet-conveying endless belt of any of the first to eighth modes, wherein the rubber-like elastic member has a textured surface.

A tenth mode of the present invention is directed to the paper-sheet-conveying endless belt of any of the first to ninth modes, wherein the core member has an inner surface having increased friction coefficient.

An eleventh mode of the present invention is directed to the paper-sheet-conveying endless belt of any of the first to tenth modes, which exhibits a percent elongation of 3% or less upon application of a tensile force of 12 N.

In a twelfth mode of the present invention, there is provided a method for producing a paper-sheet-conveying endless belt by means of a mold assembly including an inner mold and an outer mold, the method comprising covering the inner mold with a heat-shrinkable tube serving as a core member; placing the outer mold so as to surround the tube; charging a castable urethane material in a space provided between the tube and the outer mold, the urethane material being the raw material of a rubber-like elastic member; and curing the rubber-like elastic member raw material under heating.

The present invention provides a paper-sheet-conveying endless belt having thin core member and exhibits excellent durability through a small number of production steps. That is, at low cost, the present invention provides a paper-sheet-conveying endless belt which exhibits sufficient mechanical properties of a rubber-like elastic member thereof and which exhibits excellent durability. The present invention also provides a method for producing this endless belt.

### BRIEF DESCRIPTION OF THE DRAWINGS

Various other objects, features, and many of the attendant advantages of the present invention will be readily appreciated as the same becomes better understood with reference to the following detailed description of the preferred embodiments when considered in connection with the accompanying drawings, in which;

FIGS. 1A to 1C show an embodiment of the paper-sheet-conveying endless belt of the present invention;

FIGS. 2A and 2B illustrate a method for producing the paper-sheet-conveying endless belt of the present invention;

FIGS. 3A to 3C show another embodiment of the paper-sheet-conveying endless belt of the present invention;

FIG. 4 is a schematic representation showing a testing machine for evaluation of conveying performance, the testing machine being employed in Test Example 1;

FIG. 5 shows the results obtained in Test Example 1;

FIG. 6 is a schematic representation showing a durability testing machine being employed in Test Example 2;

FIG. 7 shows the results obtained in Test Example 2;

FIG. 8 is a schematic representation showing the measuring method employed in Test Example 3;

FIG. 9 is a schematic representation showing the measuring method employed in Test Example 4; and

FIG. 10 shows the results obtained in Test Example 4.

### DETAILED DESCRIPTION OF PREFERRED EMBODIMENTS

The paper-sheet-conveying endless belt of the present invention includes a core member formed of a heat-shrinkable tube, and a rubber-like elastic member provided thereon. Unlike a conventional core member formed of fibrous material, the core member employed in the present invention, which is formed of a heat-shrinkable tube, can be employed without being broken. The core member employed in the present invention can be formed so as to have a thickness much smaller than that of such a conventional core member. Thinning the core member of the paper-sheet-conveying endless belt enables the rubber-like elastic member to exhibit sufficient mechanical properties.

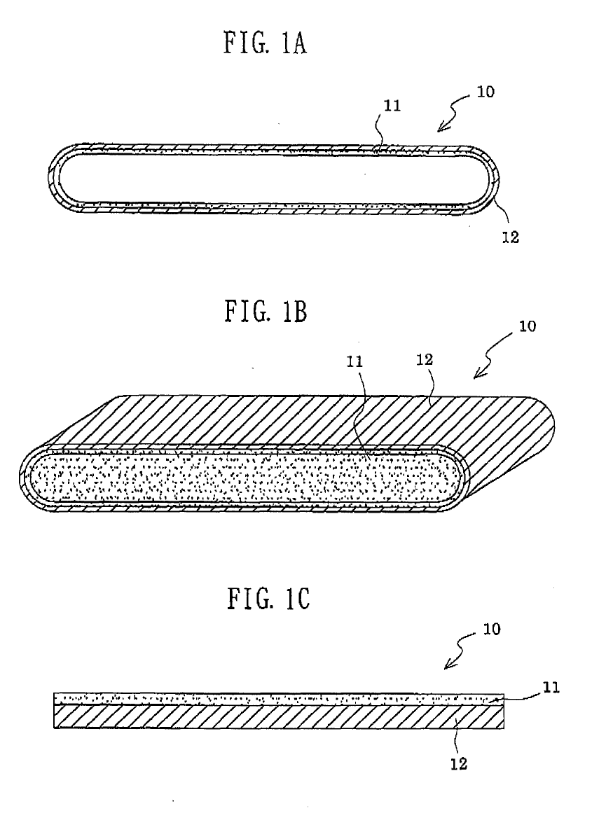

FIGS. 1A to 1C show an embodiment of the paper-sheet-conveying endless belt of the present invention. FIGS. 1A, 1B, and 1C are a cross-sectional view, a perspective view, and a partially enlarged cross-sectional view of the endless belt, respectively.

As shown in FIGS. 1A to 1C, the paper-sheet-conveying endless belt 10 includes a core member 11 formed of a heat-shrinkable tube, and a rubber-like elastic member 12 provided thereon.

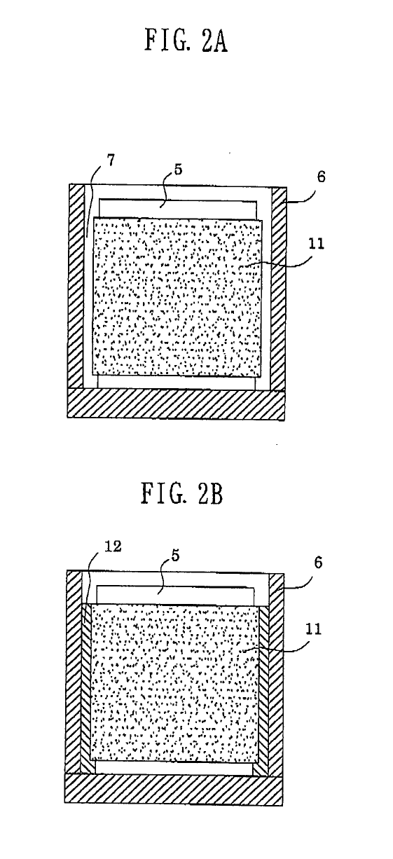

A method for producing the paper-sheet-conveying endless belt shown in FIGS. 1A to 1C will next be described with reference to FIGS. 2A and 2B.

Firstly, as shown in FIG. 2A, the core member 11 whose outer surface is coated with an adhesive is provided so as to cover a cylindrical inner mold 5, and an outer mold 6 is placed so as to surround the core member 11. The cylindrical inner mold 5 and the outer mold 6 constitute a mold assembly.

Subsequently, as shown in FIG. 2B, raw material of the rubber-like elastic member 12 is charged into a space 7 provided between the core member 11 and the outer mold 6.

Subsequently, the entirety of cylindrical inner mold 5 and the outer mold 6 are heated, to thereby cure the raw material of the rubber-like elastic member 12. In this case, the core member 11 is shrunk through heating.

Finally, the rubber-like elastic member 12 combined with the core member 11 is removed from the mold assembly, and then is cut by means of a cutting tool so as to have a predetermined width, to thereby yield the paper-sheet-conveying endless belt 10 shown in FIGS. 1A to 1C.

The outer mold 6 has an inner diameter almost equal to the outer diameter of the paper-sheet-conveying endless belt 10. In the case where a pattern is formed on the outer surface of the paper-sheet-conveying endless belt 10, a transfer pattern (negative pattern) corresponding to the pattern which is to be formed on the surface of the rubber-like elastic member 12 is provided on the inner surface of the outer mold 6.

The heat-shrinkable tube constituting the core member 11 employed in the present invention, which has been formed in advance through molding of a heat-shrinkable synthetic resin, is shrunk through heating at a predetermined percent shrinkage. In the case of formation of the paper-sheet-conveying endless belt 10, when the cylindrical inner mold 5 is covered with the heat-shrinkable tube (core member 11), followed by heating, the heat-shrinkable tube comes into close contact with the cylindrical inner mold 5. Therefore, the paper-sheet-conveying endless belt 10, which includes the heat-shrinkable tube serving as the core member 11, exhibits good dimensional accuracy.

No particular limitation is imposed on the material of the heat-shrinkable tube, but the material is preferably a material which is readily bonded to the rubber-like elastic member 12. Examples of such a material include polycarbonate (PC), polyimide (PI), perfluoroalkoxy (PFA) resin, and polyvinylidene fluoride (PVDF).

The heat-shrinkable tube preferably has a percent shrinkage of 0.5 to 10%. When the cylindrical inner mold 5 is covered with the core member 11 (heat-shrinkable tube), a small clearance is provided between the core member 11 and the cylindrical inner mold 5. The core member 11 comes into close contact with the cylindrical inner mold 5 through shrinkage of the core member 11. When the heat-shrinkable tube has a percent shrinkage of 0.5%, a sufficient clearance can be provided between the tube and the cylindrical inner mold 5, and the tube can be brought into close contact with the mold 5 through thermal shrinkage of the tube. In contrast, when the heat-shrinkable tube has a percent shrinkage of more than 10%, and a large clearance is provided between the tube and the cylindrical inner mold, the core member 11 may be irregularly shrunken, which is not preferred. Therefore, for the heat-shrinkable tube employed in the present invention, it is sufficient to have a percent shrinkage of 10% or less. When the percent shrinkage falls within a range of 0.5 to 10%, the paper-sheet-conveying endless belt exhibits good dimensional accuracy. As used herein, the term “percent shrinkage” refers to percent shrinkage in a radial direction.

The thickness of the core member 11 is preferably 20 to 500 μm, more preferably 20 to 200 μm. The ratio of the thickness of the core member 11 to the overall thickness of the paper-sheet-conveying endless belt 10 is preferably 5 to 80%, more preferably 5 to 20%. When the thickness and the thickness ratio are regulated so as to fall within the above ranges, the rubber-like elastic member 12 of the paper-sheet-conveying endless belt can exhibit sufficient mechanical properties.

In the present embodiment, since an adhesive is applied to a portion of the core member 11 that is bonded to the rubber-like elastic member 12, adhesion between the core member 11 and the rubber-like elastic member 12 is enhanced. No particular limitation is imposed on the material of the adhesive, so long as the adhesive can achieve reliable adhesion between the core member 11 and the rubber-like elastic member 12.

Needless to say, when the core member 11 and the rubber-like elastic member 12 are sufficiently bonded to each other through, for example, vulcanization, application of an adhesive may be omitted.

Preferably, the paper-sheet-conveying endless belt of the present invention is subjected to a treatment for increasing the friction coefficient of the inner surface of the core member. Through a treatment for increasing the friction coefficient of the inner surface of the core member, the friction coefficient of the inner surface of the paper-sheet-conveying endless belt is increased, and a drive pulley driven so as to come into contact with the inner surface of the paper-sheet-conveying endless belt exhibits improved driving performance.

The treatment for increasing the friction coefficient of the inner surface of the core member may be, for example, a treatment for roughening the inner surface of the core member. Specific examples of the roughening treatment include primer treatment, etching, and grinding. As used herein, the term “primer treatment” refers to a treatment in which a primer is applied to the inner surface of the core member, followed by drying. Through this treatment, a primer layer is formed on the inner surface of the core member. The primer layer is, for example, a very thin layer having a thickness of 50 μm or less. No particular limitation is imposed on the material of the primer, and the primer material may be, for example, a silicone material.

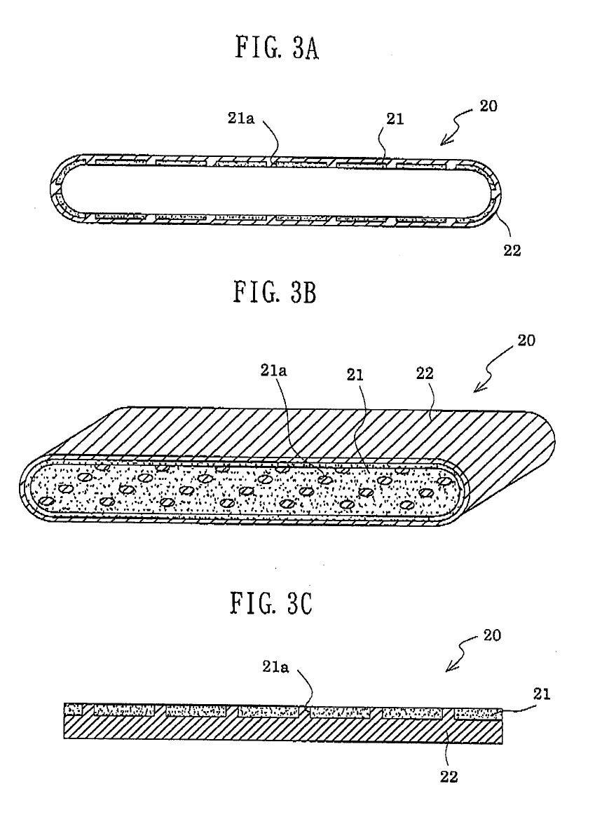

FIGS. 3A to 3C show another embodiment of the paper-sheet-conveying endless belt of the present invention. FIGS. 3A, 3B, and 3C are a cross-sectional view, a perspective view, and a partially enlarged cross-sectional view of the endless belt, respectively.

In the paper-sheet-conveying endless belt of the present invention, as shown in FIGS. 3A to 3C, a core member 21 may have through-holes 21a which penetrate therethrough in a thickness direction. When the through-holes 21a are provided in the core member 21, the through-holes 21a are filled with a rubber-like elastic member 22. When the through-holes 21a are filled with the rubber-like elastic member 22, since the core member 21 is combined with the rubber-like elastic member 22, unlike the case of the aforementioned production process, an adhesive is not necessarily applied to the outer surface of the core member 21. In addition, this combined structure can prevent the rubber-like elastic member 22 from being displaced with respect to the core member 21, which might otherwise occur during conveying of a paper sheet. Needless to say, an adhesive may be applied to the outer surface of the core member 21 having the through-holes 21a.

In the paper-sheet-conveying endless belt 20 of the present embodiment, since the rubber-like elastic member 22 reaches the inner surface of the endless belt 20 (i.e., the inner surface of the core member 21), the friction coefficient of the inner surface of the endless belt 20 is increased, and a drive pulley driven so as to come into contact with the inner surface of the endless belt 20 exhibits improved driving performance. Therefore, a treatment for increasing the friction coefficient of the inner surface of the core member (heat-shrinkable tube) 21 may be omitted. Needless to say, the core member 21 may be subjected to such a treatment.

No particular limitation is imposed on the shape, size, and arrangement of through-holes 21a, but, preferably, through-holes 21a having, for example, a circular, elliptical, or rectangular shape are provided at equi-intervals. This is because, when the through-holes 21a are provided at equi-intervals, adhesive strength is uniform throughout the interface between the core member 21 and the rubber-like elastic member 22. The total cross-sectional area of the through-holes 21a is preferably 40% or less (more preferably 20% or less) of the inner surface area of the core member 21. This is because, when the total area of the through-hole-corresponding regions exceeds 40% of the entire inner surface area, the core member 21 may fail to exhibit its effects sufficiently.

The rubber-like elastic member constituting the paper-sheet-conveying endless belt of the present invention may be formed from any known material, but is preferably formed from a castable polyurethane. When the rubber-like elastic member is formed from a castable polyurethane material, the elastic member exhibits excellent wear resistance, and the paper-sheet-conveying endless belt exhibits excellent durability.

A castable liquid polyurethane contains a high-molecular-weight polyol, an isocyanate compound, a chain extender, and a cross-linking agent. Examples of the polyol include polyester polyol, polycarbonate polyol, polyether polyol, and polycarbonate ether polyol. Examples of the isocyanate compound include 4,4′-diphenylmethane diisocyanate (MDI), 2,6-toluene diisocyanate (TDI), 1,5-naphthalene diisocyanate (NDI), 3,3-dimethyldiphenyl-4-diisocyanate (TODI), and p-phenylene diisocyanate (PPDI). The cross-linking agent employed must contain at least a short-chain diol and a short-chain triol. No particular limitation is imposed on the short-chain diol employed, but the short-chain diol is preferably at least one of propanediol (PD) and butanediol (BD). Typical examples of propanediol include 1,3-propanediol, and typical examples of butanediol include 1,4-butanediol. From the viewpoints of performance and cost, the short-chain diol employed is preferably 1,3-propanediol or 1,4-butanediol, but is not necessarily limited thereto. No particular limitation is imposed on the short-chain triol employed, but the short-chain triol is preferably at least one of trimethylolethane (TME) and trimethylolpropane (TMP). Needless to say, these short-chain diols or short-chain triols may be employed in combination of two or more species.

When the core member is formed of a heat-shrinkable tube, and the rubber-like elastic member is formed from a castable polyurethane material, the paper-sheet-conveying endless belt exhibits good dimensional stability and excellent wear resistance.

Preferably, the surface of the rubber-like elastic member employed in the present invention is subjected to texturing. This is because, a decrease in conveying force attributed to paper dust or foreign matter can be suppressed, grinding can be omitted, and molding cost can be reduced. However, the surface of the rubber-like elastic member is not necessarily subjected to texturing. For example, the surface of the elastic member may be subjected to knurling, or may have an irregular pattern. Alternatively, the surface of the elastic member may have no pattern.

The rubber-like elastic member has a rubber hardness of 20 to 80° (preferably 30 to 50°) as measured according to JIS A. This is because, when the rubber hardness is below the above range, difficulty is encountered in attaining sufficient mechanical strength, whereas when the rubber hardness exceeds the above range, sufficient friction coefficient fails to be attained, and conveying force is reduced.

No particular limitation is imposed on the thickness of the paper-sheet-conveying endless belt of the present invention, but the thickness is generally 0.5 to 2.0 mm. This is because, when the thickness is below the above range, the endless belt exhibits insufficient mechanical strength, whereas when the thickness exceeds the above range, difficulty is encountered in attaining sufficient tensibility, and uniformity in mechanical strength may fail to be attained.

Preferably, the paper-sheet-conveying endless belt of the present invention exhibits a percent elongation of 3% or less upon application of a tensile force of 12 N. When the paper-sheet-conveying endless belt is mounted in a practically used apparatus, a load of 12 N or less is applied to the endless belt. Therefore, when the paper-sheet-conveying endless belt exhibits a percent elongation of 3% or less upon application of a tensile force of 12 N, even if the endless belt is employed over a long period of time, the endless belt is not elongated, and the endless belt can maintain its mechanical strength at a sufficient level.

The paper-sheet-conveying endless belt production method of the present invention employs a heat-shrinkable tube as a core member, and thus requires a small number of production steps, as compared with the case of production of a conventional paper-sheet-conveying endless belt including a core member formed of fibrous material. Therefore, the production method of the present invention can produce a paper-sheet-conveying endless belt at low cost.

### EXAMPLES

The present invention will next be described in detail by way of Examples, which should not be construed as limiting the invention thereto.

### Example 1

An adhesive (Saivinol UF60, product of SAIDEN CHEMICAL INDUSTRY CO., LTD.) was applied to both surfaces of a PFA heat-shrinkable tube (product of Gunze Limited) having a nominal inner diameter φ of 41 mm, a thickness of 50 μm, and a percent thermal shrinkage of 8%, and a cylindrical inner mold having a nominal outer diameter φ of 41 mm was covered with the tube.

Subsequently, an outer mold having a nominal inner diameter φ of 43 mm was provided so as to surround the cylindrical inner mold combined with the heat-shrinkable tube, and to be coaxial with the inner mold. Subsequently, an uncured urethane composition containing a polyether, MDI, a short-chain diol, and a triol was charged into a space provided between the cylindrical inner mold and the outer mold, followed by curing at 140° C. for 20 minutes. Thereafter, the resultant product was removed from the molds, and then was cut by means of a cutting tool so as to have a predetermined width, to thereby yield a paper-sheet-conveying endless belt having a size of φ43 mm×φ41 mm×25 mm and a hardness of 40° (JIS A).

### Example 2

The procedure of Example 1 was repeated, except that the thickness of the heat-shrinkable tube was changed to 100 μm, to thereby yield a paper-sheet-conveying endless belt.

### Example 3

The procedure of Example 1 was repeated, except that a plurality of through-holes (φ2 mm) were provided in the heat-shrinkable tube so that the total cross-sectional area of the through-holes was 10% of the inner surface area of the tube; and an adhesive (Saivinol UF60) was applied only to the surface of the tube which came into contact with urethane rubber, to thereby yield a paper-sheet-conveying endless belt.

### Example 4

The procedure of Example 2 was repeated, except that a plurality of through-holes (φ4 mm) were provided in the heat-shrinkable tube so that the total cross-sectional area of the through-holes was 30% of the inner surface area of the tube; and an adhesive (Saivinol UF60) was applied only to the surface of the tube which came into contact with urethane rubber, to thereby yield a paper-sheet-conveying endless belt.

### Example 5

The procedure of Example 1 was repeated, except that the outer mold having a nominal inner diameter φ of 43 mm was replaced by an outer mold having a nominal inner diameter φ of 44.2 mm, to thereby yield a paper-sheet-conveying endless belt.

### Example 6

The procedure of Example 1 was repeated, except that an adhesive (Saivinol UF60) was applied only to the surface of the heat-shrinkable tube which came into contact with urethane rubber, to thereby yield a paper-sheet-conveying endless belt.

### Example 7

The procedure of Example 1 was repeated, except that a polycarbonate (PC) tube having a nominal inner diameter φ of 41 mm, a thickness of 400 μm, and a percent thermal shrinkage of 1% was employed as a core member, to thereby yield a paper-sheet-conveying endless belt.

### Comparative Example 1

A cylindrical inner mold similar to that employed in the Examples was covered with a nylon fabric core member, and a polyethylene terephthalate (PET) core member was spirally wound around the fabric core member at a pitch of 0.8 mm. A gum prepared by dissolving, in toluene, the same ethylene propylene diene rubber (EPDM) as employed in a belt main body was applied to the thus-wound core member, followed by drying.

Subsequently, the resultant core member was covered with an extrusion-molded EPDM rubber tube, and then a film was wound around the tube, followed by vulcanization in a vulcanizing can. Thereafter, the resultant product was removed from the vulcanizing can; the surface of the product was ground by means of a grinding machine; and the product was subjected to cutting so as to have a predetermined width, to thereby yield a paper-sheet-conveying endless belt having a size of φ43 mm×φ41 mm×25 mm and a hardness of 35°(JIS A).

### Comparative Example 2

The procedure of Comparative Example 1 was repeated, except that the gum prepared by dissolving EPDM in toluene was replaced by a urethane-containing gum, and the EPDM rubber tube was replaced by a tube formed of millable urethane having a hardness of 42° (JIS A), to thereby yield a paper-sheet-conveying endless belt.

### Comparative Example 3

The procedure of Example 1 was repeated, except that a heat-shrinkable tube was not employed, to thereby yield a paper-sheet-conveying endless belt.

### Comparative Example 4

The procedure of Comparative Example 3 was repeated, except that urethane rubber having a hardness of 70° (JIS A) was prepared by varying the amount of MDI incorporated and the type of a trial, to thereby yield a paper-sheet-conveying endless belt.

Table 1 shows conditions of the paper-sheet-conveying endless belts obtained in Examples 1 to 7 and Comparative Examples 1 to 4.

TABLE 1

| | | | | | Core |
|---|---|---|---|---|---|
| | | Rubber | | Belt | member |
| | Rubber-like elastic | hardness | | thickness | thickness |
| | member | (°) | Core member | (mm) | ratio (%) |
| Ex. 1 | Castable urethane | 40 | PFA tube (50 μm) | 1.0 | 5.0 |
| Ex. 2 | Castable urethane | 40 | PFA tube (100 μm) | 1.0 | 10.0 |
| Ex. 3 | Castable urethane | 40 | PFA tube (50 μm) | 1.0 | 5.0 |
| Ex. 4 | Castable urethane | 40 | PFA tube (100 μm) | 1.0 | 10.0 |
| Ex. 5 | Castable urethane | 40 | PFA tube (50 μm) | 0.6 | 8.3 |
| Ex. 6 | Castable urethane | 40 | PFA tube (50 μm) | 1.0 | 5.0 |
| Ex. 7 | Castable urethane | 40 | PC tube (400 μm) | 1.0 | 40.0 |
| Comp. Ex. 1 | EPDM | 35 | Nylon fabric | 1.0 | — |
| Comp. Ex. 2 | Millable urethane | 42 | Nylon fabric | 1.0 | — |
| Comp. Ex. 3 | Castable urethane | 40 | None | 1.0 | — |
| Comp. Ex. 4 | Castable urethane | 70 | None | 1.0 | — |

Table 2 shows production steps for the paper-sheet-conveying endless belts of the Examples and Comparative Examples 1 and 2.

TABLE 2

| Step | Examples | Comparative Examples 1 and 2 |
|---|---|---|
| 1 | Adhesive application | Nylon covering |
| 2 | Tube covering | PET winding |
| 3 | Rubber injection | Adhesive application |
| 4 | Curing | Rubber covering |
| 5 | Mold removal | Film winding |
| 6 | — | Vulcanization |
| 7 | — | Mold removal |

As is clear from Table 2, the paper-sheet-conveying endless belts of the Examples are produced through fewer production steps as compared with the cases of the paper-sheet-conveying endless belts of Comparative Examples 1 and 2, This indicates that the paper-sheet-conveying endless belt of the present invention can be produced through a small number of production steps at low cost.

### Test Example 1

### Evaluation of Conveying Performance

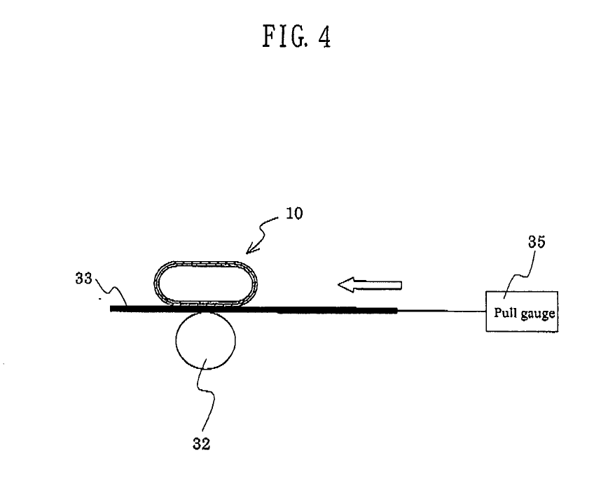

An ADF section of Imagio MF 1530 (product of Ricoh Co., Ltd.) was employed as a testing machine for evaluation of conveying performance. FIG. 4 is a schematic representation showing the testing machine for evaluation of conveying performance.

A pick-up roller was removed, and a separation roller was replaced by a free roller 32 formed of fluorocarbon resin. A paper sheet 33 was provided on the free roller 32, and each of the paper-sheet-conveying endless belts 10 of Examples 1, 3, and 7 and Comparative Examples 1 and 2 was provided on the paper sheet 33, followed by operation of the machine. In this case, force for conveying the paper sheet 33 (i.e., conveying force) (gf) was measured by means of a pull gauge 35.

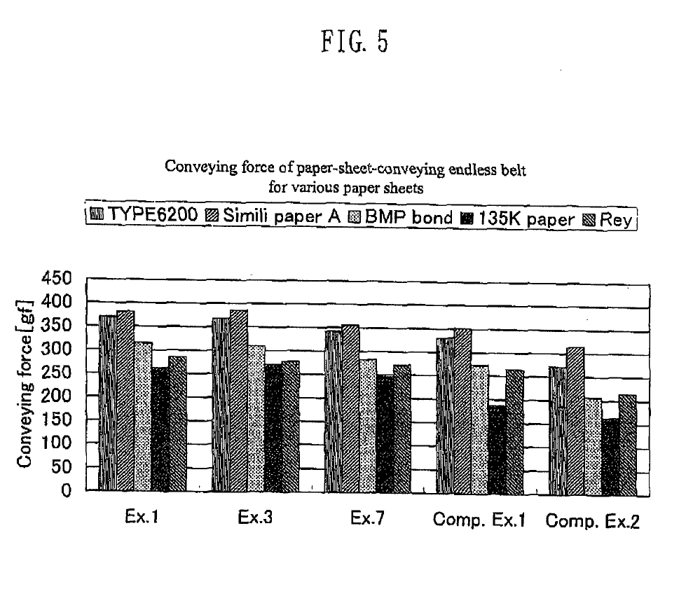

Conveying force was measured at ambient temperature and ambient humidity (NN: 23° C., 50% RH). There was employed, as the paper sheet 33, TYPE 6200 (product of Ricoh Co., Ltd.), Simili paper A (product of Ricoh Co., Ltd.), BMP-bond (product of BADGER), 135K paper (product of Ricoh Co., Ltd.), or Rey (product of INTERNATIONAL PAPER). The results are shown in Table 3 and FIG. 5.

TABLE 3

| | | | | | Comp. | Comp. |
|---|---|---|---|---|---|---|
| | | Ex. 1 | Ex. 3 | Ex. 7 | Ex. 1 | Ex. 2 |
| Conveying | TYPE 6200 | 370 | 368 | 342 | 331 | 272 |
| force | Simili paper A | 381 | 385 | 355 | 351 | 314 |
| (gf) | BMP-bond | 315 | 310 | 282 | 273 | 206 |
| | 135K paper | 262 | 271 | 247 | 187 | 164 |
| | Rey | 286 | 277 | 271 | 264 | 214 |

As is clear from Table 3 and FIG. 5, in the case where any of the aforementioned paper sheets is employed, the paper-sheet-conveying endless belt of Example 1, 3, or 7 exhibits a conveying force greater than that of the paper-sheet-conveying endless belt of Comparative Example 1 or 2. This indicates that the paper-sheet-conveying endless belt of the present invention exhibits a conveying force greater than that of a paper-sheet-conveying endless belt including a fabric core member.

### Test Example 2

### Evaluation of Wear Resistance

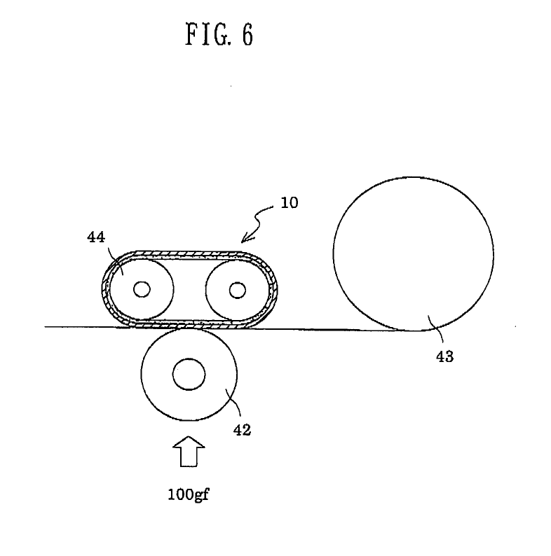

Wear resistance of each of the paper-sheet-conveying endless belts of Examples 1 and 7 and Comparative Examples 1 and 2 was evaluated at ambient temperature and ambient humidity by means of a durability testing machine shown in FIG. 6. In this durability testing machine, wear is forcibly generated by providing a large difference between the rotation speed of a roller and the traveling speed of a paper sheet. A free roller 42 was provided so as to face the paper-sheet-conveying endless belt 10, and a rolled paper sheet 43 formed of plain paper (64 g/m²) was unrolled and fed at 20 mm/sec while the free roller 42 was pressed to the endless belt 10 at a load of 100 gf, After a driving roller 44 provided so as to come into contact with the inner surface of the paper-sheet-conveying endless belt 10 was rotated 25,000 times at 400 rpm, the weight of the endless belt 10 was measured, and the percent change in weight of the belt was determined by use of the weights of the belt as measured before and after the test. Wear resistance of the endless belt 10 was evaluated by the percent change in weight as determined by the following formula.

Percent change in weight (%)=100×(weight before the test−weight after the test)/(weight before the test)

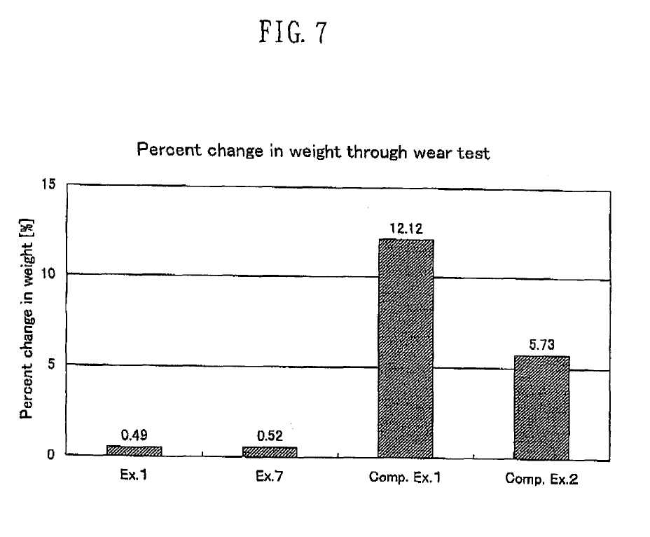

The results are shown in Table 4 and FIG. 7

TABLE 4

| | | | Comp. | Comp. |
|---|---|---|---|---|
| | Ex. 1 | Ex. 7 | Ex. 1 | Ex. 2 |
| Percent change in weight (%) | 0.49 | 0.52 | 12.12 | 5.73 |

As is clear from Table 4 and FIG. 7, the paper-sheet-conveying endless belt of Example 1 or 7 exhibits excellent wear resistance, as compared with the case of the paper-sheet-conveying endless belt of Comparative Example 1 or 2.

### Test Example 3

### Measurement of Percent Elongation

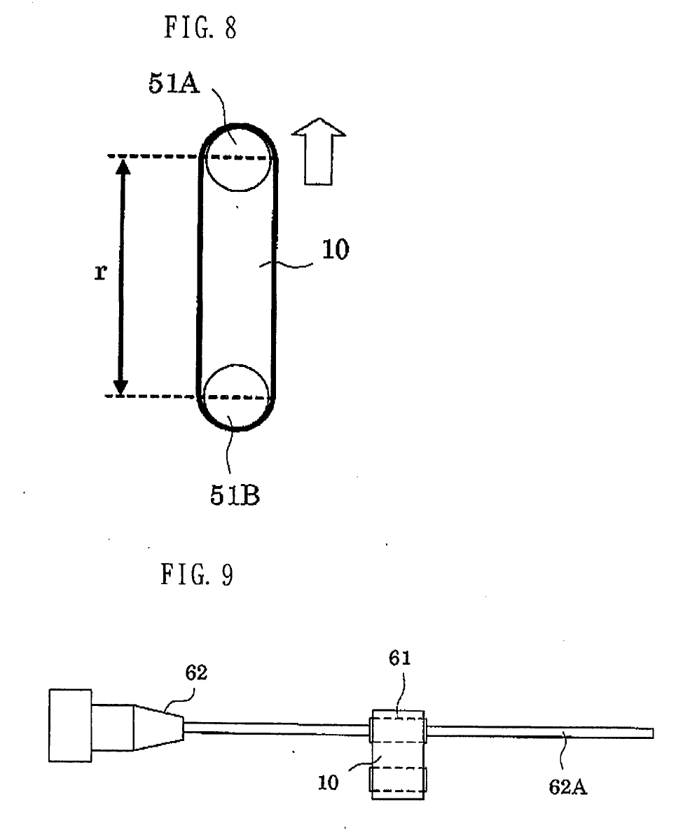

As shown in FIG. 8, each of the paper-sheet-conveying endless belts 10 of Examples 1, 2, and 5 and Comparative Examples 1 to 4 was applied to shafts 51A and 51B of a tensile testing machine. Tensile force was applied to the paper-sheet-conveying endless belt 10 by increasing the distance between the shafts (i.e., intershaft distance), and the intershaft distance was measured at the time when a tensile force of 12 N was applied to the endless belt. Percent elongation of the paper-sheet-conveying endless belt 10 was determined by use of the below-described formula. For each of the paper-sheet-conveying endless belts 10, three samples were subjected to the measurement, and the average value of the samples was regarded as the percent elongation of the endless belt 10. The results are shown in Table 5.

Percent elongation (%)=100×(intershaft distance upon application of a tensile force of 12 N−initial intershaft distance)/(initial intershaft distance)

TABLE 5

| | | | | Comp. | Comp. | Comp. | Comp. |
|---|---|---|---|---|---|---|---|
| | Ex. 1 | Ex. 2 | Ex. 5 | Ex. 1 | Ex. 2 | Ex. 3 | Ex. 4 |
| Percent | 1.6 | 1.6 | 2.0 | 1.8 | 2.0 | more | 5.5 |
| elongation | | | | | | than | |
| (%) upon | | | | | | 8.5 | |
| application | | | | | | | |
| of a tensile | | | | | | | |
| force of | | | | | | | |
| 12 N | | | | | | | |

As is clear from Table 5, the paper-sheet-conveying endless belt of Example 1, 2, or 5 exhibits a percent elongation lower than that of the paper-sheet-conveying endless belt of Comparative Example 3 or 4, which does not include a resin tube; i.e., the paper-sheet-conveying endless belt of Example 1, 2, or 5 exhibits excellent mechanical strength. As is also clear from Table 5, the paper-sheet-conveying endless belt of Example 1, 2, or 5 exhibits a percent elongation equal to or lower than that of the paper-sheet-conveying endless belt of Comparative Example 1 or 2, which includes a nylon fabric core member, The paper-sheet-conveying endless belt of Comparative Example 3 exhibited a very high percent elongation; i.e., the percent elongation thereof had already reached 8.5% upon application of a tensile force of 8 N.

These data indicate that even when employed over a long period of time, the paper-sheet-conveying endless belt of the present invention is not elongated, and can maintain its mechanical strength at a sufficient level.

### Test Example 4

### Torque Measurement

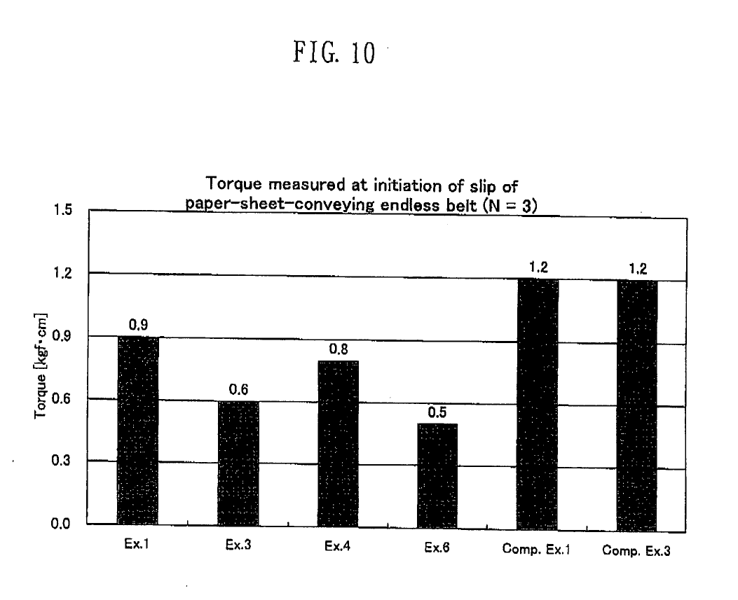

Each of the paper-sheet-conveying endless belts 10 of Examples 1, 3, 4, and 6 and Comparative Examples 1 and 3 was applied to a pulley 61 so that the inner surface of the belt comes into contact with the pulley 61. Subsequently, as shown in FIG. 9, the pulley 61 was mounted on a shaft 62A of a torque gauge 62, and torque was measured at the moment when the pulley 61 slipped over the inner surface of the paper-sheet-conveying endless belt 10. For each of the paper-sheet-conveying endless belts 10, three samples were subjected to the measurement, and the average value of the samples was determined. The results are shown in FIG. 10.

The paper-sheet-conveying endless belt of Example 1, in which an adhesive was applied to the inner surface of the heat-shrinkable tube, was found to have a torque higher than that of the paper-sheet-conveying endless belt of Example 6, in which an adhesive was not applied to the inner surface of the heat-shrinkable tube. This finding indicates that when the inner surface of the heat-shrinkable tube is subjected to primer treatment (application of an adhesive), the friction coefficient of the inner surface of the paper-sheet-conveying endless belt is increased, and thus the torque of the endless belt is enhanced, whereby slip is less likely to occur between the endless belt and the pulley provided so as to come into contact with the inner surface of the belt.

The paper-sheet-conveying endless belt of Example 3 or 4, in which through-holes were provided in the heat-shrinkable tube, was found to have a torque higher than that of the paper-sheet-conveying endless belt of Example 6. This finding indicates that when through-holes are provided in the heat-shrinkable tube, the friction coefficient of the inner surface of the paper-sheet-conveying endless belt is increased, and thus the torque of the endless belt is enhanced, whereby slip is less likely to occur between the endless belt and the pulley provided so as to come into contact with the inner surface of the belt.

Although each of the paper-sheet-conveying endless belts of Examples 1, 3, 4, and 6 exhibits a torque lower than that of the paper-sheet-conveying endless belt of Comparative Example 1 or 3, such a torque level does not cause any problem in practical use.

The above-described data show that the paper-sheet-conveying endless belt of the present invention (i.e., each of the endless belts of Examples 1 to 7) exhibits sufficient coefficient of friction against a pulley, high conveying force (Test Example 1), and excellent wear resistance (Test Example 2).

What is claimed is:

1. A paper-sheet-conveying endless belt comprising a core member formed of a heat-shrinkable tube, and a rubber-like elastic member provided thereon.

2. A paper-sheet-conveying endless belt according to claim 1, wherein the core member has a through-hole which penetrates therethrough in a thickness direction, and the through-hole is filled with the rubber-like elastic member.

3. A paper-sheet-conveying endless belt according to claim 1, wherein the rubber-like elastic member is formed from a castable polyurethane.

4. A paper-sheet-conveying endless belt according to claim 1, wherein the heat-shrinkable tube has a percent shrinkage of 0.5 to 10%.

5. A paper-sheet-conveying endless belt according to claim 1, wherein the core member has a thickness of 20 to 500 μm.

6. A paper-sheet-conveying endless belt according to claim 5, wherein the thickness of the core member is 20 to 200 μm.

7. A paper-sheet-conveying endless belt according to claim 1, wherein the ratio of the thickness of the core member to the overall thickness of the endless belt is 5 to 80%.

8. A paper-sheet-conveying endless belt according to claim 7, wherein the ratio of the thickness of the core member to the overall thickness of the endless belt is 5 to 20%.

9. A paper-sheet-conveying endless belt according to claim 1, wherein the rubber-like elastic member has a textured surface.

10. A paper-sheet-conveying endless belt according to claim 1, wherein the core member has an inner surface having increased friction coefficient.

11. A paper-sheet-conveying endless belt according to claim 1, which exhibits a percent elongation of 3% or less upon application of a tensile force of 12 N.

12. A method for producing a paper-sheet-conveying endless belt by means of a mold assembly including an inner mold and an outer mold, the method comprising covering the inner mold with a heat-shrinkable tube serving as a core member; placing the outer mold so as to surround the tube; charging a castable urethane material in a space provided between the tube and the outer mold, the urethane material being the raw material of a rubber-like elastic member; and curing the rubber-like elastic member raw material under heating.
